(19) United States
(12) Patent Application Publication
(10) Pub. No.: US 2026/0134553 A1
(43) Pub. Date: May 14, 2026

(54) MOTION ESTIMATION WITH DEPTH INFORMATION

(71) Applicant: QUALCOMM Incorporated, San Diego, CA (US)

(72) Inventors: Sujabrata MALLICK, Barddhaman (IN); Sanjaya Kumar NAYAK, Balasore (IN); Sandeep RAMISETTY, Hyderabad (IN); Joshin MATHEW, Kottarakkara (IN); Suresh Kumar NEHRA, Sikar (IN); Phani Bhushan THOLETI, Hyderabad (IN); Pradeep VEERAMALLA, Hyderabad (IN)

(21) Appl. No.: 18/943,589

(22) Filed: Nov. 11, 2024

(51) Int. Cl. G06T 7/246; G06T 3/147; G06T 3/40; G06T 7/215; G06T 7/37; G06T 7/593

(52) U.S. Cl. CPC G06T 7/248; G06T 3/147; G06T 3/40; G06T 7/215; G06T 7/37; G06T 7/593; G06T 2207/20016

(57) ABSTRACT

Systems and techniques are described for image processing. For example, a computing device can determine feature points in a first image and can determine motion vectors associated with the feature points. The computing device can determine background motion vectors associated with a background of a scene of the first image. The computing device can determine, based on the background motion vectors, a transformation matrix for aligning the backgrounds of the first image and a second image. The computing device can determine a scaling factor based on a magnitude of motion vectors within a portion of a foreground of the scene of the first image and can scale, based on the scaling factor, the transformation matrix to generate a local transformation matrix for aligning the portion of the foreground of the scene of the first image with a corresponding portion of the foreground of the scene of the second image.

### FIELD

The present disclosure generally relates to image processing. For example, aspects of the present disclosure relate to robust motion estimation with depth information.

### BACKGROUND

Electronic devices are increasingly equipped with camera hardware that can be used to capture image frames (e.g., still images and/or video frames) for consumption. For example, an electronic device (e.g., a mobile device, an Internet Protocol (IP) camera, an extended reality device, a connected device, a laptop computer, a smartphone, a smart wearable device, a game console, etc.) can include one or more cameras integrated with the electronic device. The electronic device can use the camera to capture an image or video of a scene, a person, an object, or anything else of interest to a user of the electronic device. The electronic device can capture (e.g., via the camera) an image or video and process, output, and/or store the image or video for consumption (e.g., displayed on the electronic device, saved on a storage, sent or streamed to another device, etc.).

In some cases, the electronic device can further process the image or video for certain effects such as depth-of-field or portrait effects, extended reality (e.g., augmented reality, virtual reality, and the like) effects, image stylization effects, image enhancement effects, etc., and/or for certain applications such as computer vision, extended reality, object detection, recognition (e.g., face recognition, object recognition, scene recognition, etc.), compression, feature extraction, authentication, segmentation, and automation, among others. In one or more cases, the electronic device can process images of a scene to align the images with each other, such as for video coding purposes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described herein for image processing (e.g., for aligning images). In some aspects, an apparatus for aligning images is provided. The apparatus includes at least one memory and at least one processor coupled to the at least one memory and configured to: determine a plurality of feature points in a first image; determine, based on the plurality of feature points, a plurality of motion vectors associated with the plurality of feature points; determine background motion vectors of the plurality of motion vectors associated with a background of a scene of the first image; determine, based on the background motion vectors, a transformation matrix for aligning the background of the first image and the background of a second image; determine a scaling factor based on a magnitude of motion vectors of the plurality of motion vectors within a portion of a foreground of the scene of the first image; and scale, based on the scaling factor, the transformation matrix to generate a local transformation matrix for aligning the portion of the foreground of the scene of the first image with a corresponding portion of the foreground of the scene of the second image.

In some aspects, the techniques described herein relate to a method of aligning images, the method including: determining a plurality of feature points in a first image; determining, based on the plurality of feature points, a plurality of motion vectors associated with the plurality of feature points; determining background motion vectors of the plurality of motion vectors associated with a background of a scene of the first image; determining, based on the background motion vectors, a transformation matrix for aligning the background of the first image and the background of a second image; determining a scaling factor based on a magnitude of motion vectors of the plurality of motion vectors within a portion of a foreground of the scene of the first image; and scaling, based on the scaling factor, the transformation matrix to generate a local transformation matrix for aligning the portion of the foreground of the scene of the first image with a corresponding portion of the foreground of the scene of the second image.

In some aspects, a non-transitory computer-readable medium having stored thereon instructions that, when executed by at least one processor, cause the at least one processor to: determine a plurality of feature points in a first image; determine, based on the plurality of feature points, a plurality of motion vectors associated with the plurality of feature points; determine background motion vectors of the plurality of motion vectors associated with a background of a scene of the first image; determine, based on the background motion vectors, a transformation matrix for aligning the background of the first image and the background of a second image; determine a scaling factor based on a magnitude of motion vectors of the plurality of motion vectors within a portion of a foreground of the scene of the first image; and scale, based on the scaling factor, the transformation matrix to generate a local transformation matrix for aligning the portion of the foreground of the scene of the first image with a corresponding portion of the foreground of the scene of the second image.

In some aspects, an apparatus for aligning images is provided. The apparatus includes: means for determining a plurality of feature points in a first image; means for determining, based on the plurality of feature points, a plurality of motion vectors associated with the plurality of feature points; means for determining background motion vectors of the plurality of motion vectors associated with a background of a scene of the first image; means for determining, based on the background motion vectors, a transformation matrix for aligning the background of the first image and the background of a second image; means for determining a scaling factor based on a magnitude of motion vectors of the plurality of motion vectors within a portion of a foreground of the scene of the first image; and means for scaling, based on the scaling factor, the transformation matrix to generate a local transformation matrix for aligning the portion of the foreground of the scene of the first image with a corresponding portion of the foreground of the scene of the second image.

In some aspects, one or more of the apparatuses described herein is, is a part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the one or more apparatuses can include at least one camera for capturing one or more images or video frames. For example, the one or more apparatuses can include a camera (e.g., an RGB camera) or multiple cameras for capturing one or more images and/or one or more videos including video frames. In some aspects, the one or more apparatuses can include a display for displaying one or more images, videos, notifications, or other displayable data. In some aspects, the one or more apparatuses can include a transmitter configured to transmit one or more video frame and/or syntax data over a transmission medium to at least one device. In some aspects, the processor includes an image signal processor (ISP), a host processor (HP) (or application processor (AP), a neural processing unit (NPU), a central processing unit (CPU), a graphics processing unit (GPU), a digital signal process (DSP), or other processing device or component.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A illustrates a Phase Detection Auto Focus (PDAF) camera system that is in phase and therefore in focus, in accordance with aspects of the present disclosure.

FIG. 1B illustrates the PDAF camera system of FIG. 1A that is out of phase with a front focus, in accordance with aspects of the present disclosure.

FIG. 1C illustrates the PDAF camera system of FIG. 1A that is out of phase with a back focus, in accordance with aspects of the present disclosure.

FIG. 2A illustrates a top-down view of a pixel array configuration of an image sensor with masks partially covering focus pixel photodiodes, in accordance with aspects of the present disclosure.

FIG. 2B is a legend identifying elements of FIG. 2A, in accordance with aspects of the present disclosure.

FIG. 2C illustrates a top-down view of a pixel array configuration of an image sensor with two side-by-side focus pixels covered by a 2 pixel by 1 pixel microlens, in accordance with aspects of the present disclosure.

FIG. 2D illustrates a top-down view of a pixel array configuration of an image sensor with four neighboring focus pixels covered by a 2 pixel by 2 pixel microlens, in accordance with aspects of the present disclosure.

FIG. 2E illustrates a top-down view of a pixel array configuration of an image sensor in which at least one focus pixel has two photodiodes, in accordance with aspects of the present disclosure.

FIG. 2F illustrates a top-down view of a pixel array configuration of an image sensor in which at least one focus pixel has four photodiodes, in accordance with aspects of the present disclosure.

FIG. 3A illustrates a side view of a single pixel of a pixel array of an image sensor that is partially covered with a mask, in accordance with aspects of the present disclosure.

FIG. 3B illustrates a side view of two pixels of a pixel array of an image sensor, the two pixels covered by a 2 pixel by 1 pixel microlens, in accordance with aspects of the present disclosure.

FIG. 4 is a simplified block diagram illustrating an example electronic device, in accordance with aspects of the present disclosure.

FIG. 5 is a diagram illustrating an example flow for a motion estimation implementation, in accordance with aspects of the present disclosure.

FIG. 6 is a diagram illustrating an example of hierarchical motion estimation (HME) to generate an alignment transformation matrix, in accordance with aspects of the present disclosure.

FIG. 7 is a flow diagram illustrating an example of a process for robust motion estimation with depth information for generating alignment transformation matrices that minimize artifacts, in accordance with aspects of the present disclosure.

FIG. 8 is a diagram illustrating examples of images showing global motion vectors and local motion vectors within a background and a portion of a foreground of a scene, in accordance with aspects of the present disclosure.

FIG. 9 is a flow diagram illustrating an example of a process for robust motion estimation with depth information, in accordance with some aspects of the disclosure.

FIG. 10 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, electronic devices are increasingly equipped with camera hardware to capture images and/or videos for consumption. For example, an electronic device (e.g., a mobile device, an IP camera, an extended reality device, a laptop computer, a tablet computer, a smart television, a head-mounted display, smart glasses, a game console, a camera system, a connected device, a smartphone, etc.) can include a camera to allow the electronic device to capture a video or image of a scene, a person, an object, etc. The image or video can be captured and processed by the electronic device and stored or output for consumption (e.g., displayed on the electronic device and/or another device).

In some cases, the camera hardware and the images and/or video frames captured by the camera hardware can be used for a variety of applications such as, for example and without limitation, computer vision, extended reality (e.g., augmented reality, virtual reality, and the like), object detection, image recognition (e.g., face recognition, object recognition, scene recognition, etc.), feature extraction, localization, authentication, photography, automation, compression, motion estimation, image stabilization, temporal noise reduction, among others.

In one or more cases, an electronic device can process images of a scene to align the images with each other (e.g., for video coding purposes). For example, the electronic device can utilize hierarchical motion estimation (HME) to estimate an alignment transformation between two images of a scene to align the two images with each other. However, in multi-depth scenarios where only local motion (e.g., movement of one or more objects within a scene) exists, without global motion (e.g., movement caused by motion of the camera), HME can generate an inaccurate alignment transformation that can introduce artifacts (e.g., in the form of wobbling) in the aligned images.

As such, improved systems and techniques that provide a robust alignment transformation matrix that reduces artifacts, such as wobbling, in multi-depth scenes can be beneficial.

In one or more aspects of the present disclosure, systems, apparatuses, methods (also referred to as processes), and computer-readable media (collectively referred to herein as “systems and techniques”) are described herein that provide solutions for robust motion estimation with depth information.

Various aspects relate generally to image processing. Some aspects more specifically relate to systems and techniques that provide solutions that address challenges with image-based motion estimation in multi-depth and local motion scenarios, which can have large impact on image quality (IQ) in high dynamic range (HDR) and video recording use cases. In one or more examples, the systems and techniques can minimize wobbling issues, which are often observed in HDR and video recording use cases.

In one or more examples, as mentioned, in multi-depth situations where only local motion exists without any global motion, HME fails to generate proper alignment transform. Global alignment transformation estimation can be improved if feature points are intelligently selected in the HME algorithm. In some examples, those feature points can be selected from a region (e.g., either the foreground or background of a scene) which covers a majority of the field of view (FOV). In one or more examples, a PDAF algorithm may be employed for foreground and background segmentation. In some examples, an HME algorithm can be used to compute an alignment transformation from motion vectors, which are either located within the foreground or background of the scene. As such, the systems and techniques allow for estimation of more accurate alignment transformation matrix, which reduces wobbling artifacts.

In one or more aspects, during operation of a method of aligning images, one or more processors can determine a plurality of feature points in a first image. The one or more processors can determine, based on the plurality of feature points, a plurality of motion vectors associated with the plurality of feature points. The one or more processors can determine background motion vectors of the plurality of motion vectors associated with a background of a scene of the first image. The one or more processors can determine, based on the background motion vectors, a transformation matrix for aligning the background of the first image and the background of a second image. The one or more processors can determine a scaling factor based on a magnitude of motion vectors of the plurality of motion vectors within a portion of a foreground of the scene of the first image. The one or more processors can scale, based on the scaling factor, the transformation matrix to generate a local transformation matrix for aligning the portion of the foreground of the scene of the first image with a corresponding portion of the foreground of the scene of the second image.

In one or more examples, the one or more processors can determine, based on a depth map for the first image, the foreground of the scene of the first image and the background of the scene of the first image. In some examples, the one or more processors can generate, based on the first image, the depth map for the first image based on phase detection autofocus (PDAF) segmentation, contrast detection autofocus (CDAF) segmentation, or stereoscopy depth. The one or more processors can determine the foreground of a scene of the first image is less than a threshold area, and can determine, based on determining the foreground of the scene of the first image is less than the threshold area, the plurality of feature points in the first image. In some examples, the threshold area can be based on a region of interest.

In some examples, the one or more processors can, prior to determining the plurality of feature points in the first image, downscale the first image and the second image from a first resolution to a second resolution lower than the first resolution. In some examples, the first resolution is a full scale resolution, and the second resolution is a downscale (DS) 4 resolution, a DS 8 resolution, or a DS 16 resolution. In one or more examples, one or more feature points of the plurality of feature points can be determined based on a Harris Corner Detection (HCD) algorithm. In some examples, the plurality of motion vectors can be determined based on normalized cross correlation (NCC). In one or more examples, the background motion vectors can be determined based on a depth map for the first image. In some examples, the scaling factor can be further based on an average of the magnitude of the motion vectors of the plurality of motion vectors within the portion of the foreground of the scene of the first image. In one or more examples, the transformation matrix can be determined based on a random sample consensus (RANSAC) algorithm. In some examples, the one or more processors can determine the foreground of a scene of the first image is greater than a threshold area, and can generate, based on determining the foreground of the scene of the first image is greater than the threshold area, a global transformation matrix based on motion vectors of the plurality of motion vectors within the foreground of the scene of the first image.

Particular aspects of the subject matter described in this disclosure can be implemented to realize one or more of the following potential advantages. In one or more examples, the systems and techniques can provide a benefit of providing for a robust alignment transformation matrix that reduces wobbling artifacts in multi-depth scenes with only local motion present, without global motion.

Additional aspects of the present disclosure are described in more detail below.

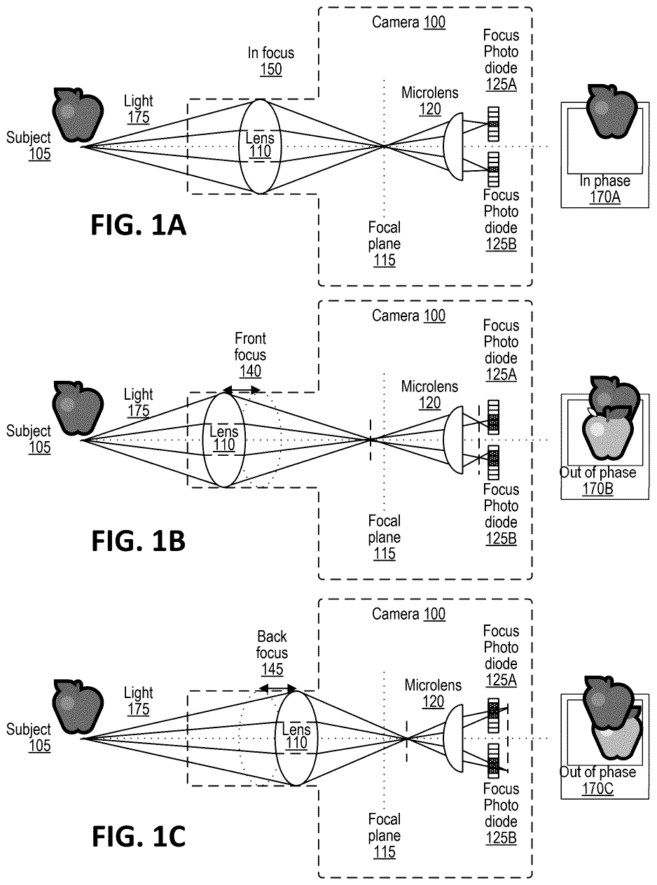

FIG. 1A illustrates a PDAF camera system that is in phase and therefore in focus. Rays of light 175 may travel from a subject 105 (e.g., an apple) through a lens 110 that focuses a scene with the subject 105 onto an image sensor (not pictured in its entirety), where the image sensor includes the focus photodiode 125A and the focus photodiode 125B, which correspond to focus pixels. The focus photodiodes 125A and 125B may be associated with one or two focus pixels (e.g., focus photodiode 125A and focus photodiode 125B may be two photodiodes of a single focus pixel sharing a single microlens 120 or focus photodiode 125A may be associated with a first focus pixel and focus photodiode 125B may be associated with a second focus pixel, both focus pixels sharing a single microlens 120) of the pixel array of the image sensor. In some cases, the light rays 175 may travel through a microlens 120 before falling on the focus photodiode 125A and the focus photodiode 125B. When the camera system 100 is in the “in focus” state 150 of FIG. 1A, the rays of light 175 may ultimately converge at a plane that corresponds to the position of the focus photodiode 125A and the focus photodiode 125B. When the camera system 100 is in the “in focus” state 150 of FIG. 1A, rays of light 175 may also converge at a focal plane 115 (also known as an image plane) after passing through the lens 175 but before reaching the microlens 120 and/or focus photodiodes 125A and 125B.

Because the camera 100 of FIG. 1A is in an in-focus state 150, data from focus photodiodes 125A and 125B is aligned, here represented by an image 170A showing a clear and sharp representation of the subject 105 due to this alignment, as opposed to the misaligned representations of the subject 105 caused by the out-of-phase states 140 and 145 in FIG. 1B and FIG. 1C, respectively. The in-focus state 150 may also be referred to as an “in-phase” state, as the data from focus photodiode 125A and the focus photodiode 125B have no phase disparity, or have very little phase disparity (e.g., phase disparity falling below a predetermined phase disparity threshold).

FIG. 1B illustrates the PDAF camera system of FIG. 1A that is out of phase with a front focus. The PDAF camera system 100 of FIG. 1B is the same as the PDAF camera system 100 of FIG. 1A, but the lens 110 is moved closer to the subject 105 and further from the focus photodiodes 125A and 125B, and is therefore in a “front focus” state 140. The lens position for the “in focus” state 150 is still drawn in FIG. 1B as a dotted outline for reference, with a double-sided arrow indicating movement of the lens between the “front focus” 140 lens position and the “in focus” 150 lens position.

When the camera system 100 is in the “front focus” state 140 of FIG. 1B, the rays of light 175 may ultimately converge at a plane (denoted by a dashed line) before the position of the focus photodiode 125A and the focus photodiode 125B, that is, between the microlens 120 and the focus photodiodes 125A and 125B. The rays of light 175 may also converge at a position (denoted by another dashed line) before the focal plane 115 after passing through the lens 175 but before reaching the microlens 120 and/or focus photodiodes 125A and 125B. Because the light 175 in the camera 100 of FIG. 1B is out of phase in the “front focus” state 140, data from focus photodiodes 125A and 125B is misaligned, here represented by an image 170B showing misaligned black-colored and white-colored representations of the subject 105, where the direction of misalignment in the image 170B is related to the front focus state 140, and the distance of misalignment in the image 170B is related to the distance of the lens 110 from its position in the focused state 150.

FIG. 1C illustrates the PDAF camera system of FIG. 1A that is out of phase with a back focus. The PDAF camera system 100 of FIG. 1C is the same as the PDAF camera system 100 of FIG. 1A, but the lens 110 is moved further from the subject 105 and closer to the focus photodiodes 125A and 125B, and is therefore in a “back focus” state 145 (also known as a “rear focus” state). The lens position for the “in focus” state 150 is still drawn as a dotted outline for reference, with a double-sided arrow indicating movement of the lens between the “back focus” lens position 145 and the “in focus” lens position 150.

When the camera system 100 is in the “back focus” state 145 of FIG. 1C, the rays of light 175 may ultimately converge at a plane (denoted by a dashed line) beyond the position of the focus photodiode 125A and the focus photodiode 125B. The rays of light 175 may also converge at a position (denoted by another dashed line) beyond the focal plane 115 after passing through the lens 175 but before reaching the microlens 120 and/or focus photodiodes 125A and 125B. Because the light 175 in the camera 100 of FIG. 1C is out of phase in the “back focus” state 145, data from focus photodiodes 125A and 125B is misaligned, here represented by an image 170C showing misaligned black-colored and white colored representations of the subject 105, where the direction of misalignment in the image 170C is related to the back focus state 145, and the distance of misalignment in the image 170C is related to the distance of the lens 110 from its position in the focused state 150.

When the rays of light 175 converge before the plane of the focus photodiodes 125A and 125B as in the front focus state 140 or beyond the plane of the focus photodiodes 125A and 125B as in the back focus state 145, the resulting image produced by the image sensor may be out-of-focus or blurred. In the case that the image is out-of-focus, the lens 110 can be moved forward (toward the subject 105 and away from the photodiodes 125A and 125B) if the lens 110 is in the back focus state 145, or can be moved backward (away from the subject 105 and toward the photodiodes 125A and 125B) if the lens is in the front focus state 140. The lens 110 may be moved forward or backward within a range of positions which in some cases has a predetermined length R representing a possible range of motion of the lens in the camera system 100. The camera system 100, or a computing system therein, may determine a distance and direction of adjusting the position of the lens 100 to bring the image into focus based on one or more phase disparity values calculated as differences between data from two focus photodiodes that receive light from different directions, such as focus photodiodes 125A and 125B. The direction of movement of the lens 110 may correspond to a direction in which the data from the focus photodiodes 125A and 125B is determined to be out of phase, or whether the phase disparity is positive or negative. The distance of movement of the lens 110 may correspond to a degree or amount to which the data from the focus photodiodes 125A and 125B is determined to be out of phase, or the absolute value of the phase disparity.

The camera 100 may include motors (not pictured) that move the lens 110 between lens positions corresponding to the different states (e.g., front focus 140, back focus 145, and in focus 150) and motor actuators (not pictured) that the computing system within the camera activates to actuate the motors. The camera 100 of FIG. 1A, FIG. 1B, and FIG. 1C may in some cases also include various additional non-illustrated components, such as lenses, mirrors, partially reflective (PR) mirrors, prisms, photodiodes, image sensors, and/or other components sometimes found in cameras or other optical equipment. In some cases, the focus photodiodes 125A and 125B may be referred to as PDAF photodiodes, PDAF diodes, phase detection (PD) photodiodes, PD diodes, PDAF pixel photodiodes, PDAF pixel diodes, PD pixel photodiodes, PD pixel diodes, focus pixel photodiodes, focus pixel diodes, pixel photodiodes, pixel diodes, or in some cases simply photodiodes or diodes.

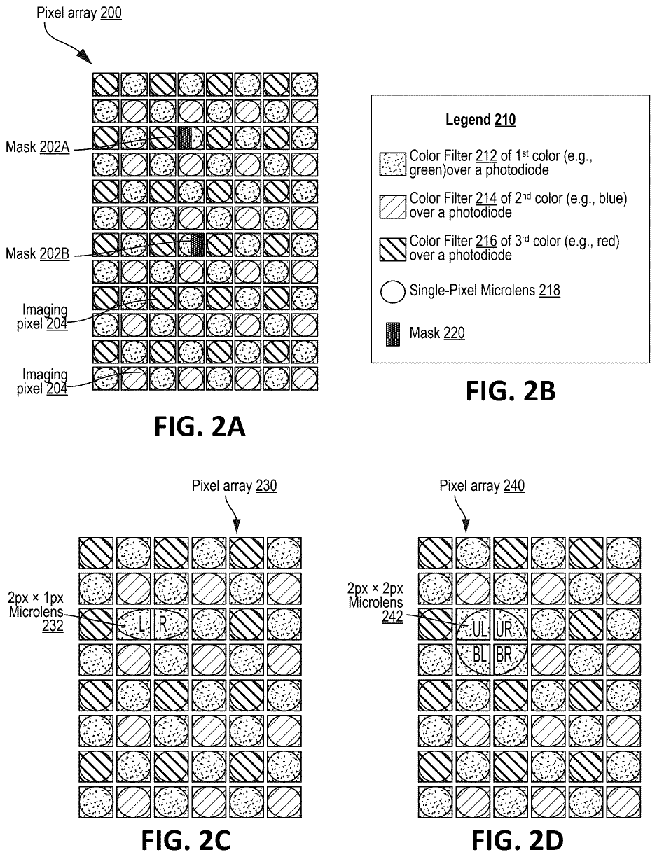

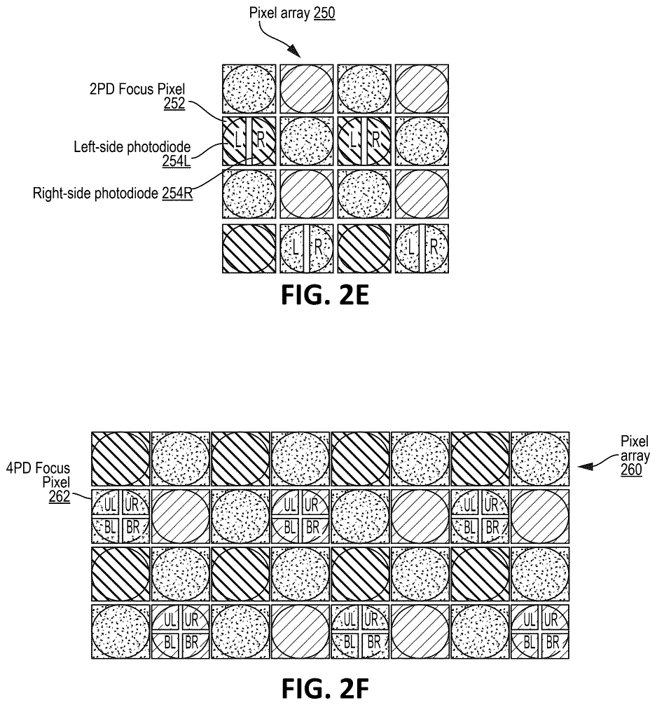

FIG. 2A illustrates a top-down view of a pixel array configuration of an image sensor with masks partially covering focus pixel photodiodes. An image sensor of a camera system may include an array of pixels, such as the pixel array 200 of FIG. 2A. The pixel array 200 may include an array of photodiodes, which is not shown in FIG. 2A as is the photodiodes are covered by color filters (e.g., Bayer filters or other types of color filters as discussed below) and microlenses 218 as identified in the legend 210 of FIG. 2B. Photodiodes of focus pixels are also partially covered by masks 220 in the pixel array 200 of FIG. 2A.

FIG. 2B is a legend identifying elements of FIG. 2A. The legend 210 identifies that a circle represents a microlens 218 of a single pixel, and that a dark shaded rectangle represents a mask 220. The legend 210 of FIG. 2B also identifies that squares with three different patterns each represent color filters 212, 214, and 216, each color filter being for one of three different colors: red, green, or blue. That is, squares of the first pattern represent a color filter 212 for a first color, which may for example be green; squares of the second pattern represent a color filter 214 for a second color, which may for example be blue; and squares of the third pattern represent a color filter 216 for a third color, which may for example be red. These color filters are arranged in color filter arrays (CFAs) over an array of photodiodes in the pixel arrays 200, 230, and 240 of FIG. 2A, FIG. 2C, and FIG. 2D, respectively. The colors (and number of colors) identified in the legend 210 of FIG. 2B, and the arrangements of color filters illustrated in the pixel arrays 200, 230, and 240 of FIG. 2A, FIG. 2C, and FIG. 2D, should be understood to be exemplary and should not be construed as limiting. Red, green, and blue color filters are traditionally used in image sensors and are often referred to as Bayer filters. Bayer filter CFAs often include more green Bayer filters than red or blue Bayer filters, for example in a proportion of 50% green, 25% red, 25% blue, to mimic sensitivity to green light in human eye physiology. Bayer filter CFAs with these proportions are sometimes referred to as BGGR, RGBG, GRGB, or RGGB, and are reflected in the presence of the color filter 212 in higher proportion than the color filters 214 and 216 in the pixel arrays 200, 230, and 240 of FIG. 2A, FIG. 2C, and FIG. 2D. Sometimes, in such Bayer filter CFAs, green is treated as two colors, labeled “Gr” and “Gb” respectively. Some CFAs use alternate color schemes and can even include more or fewer colors. For example, some CFAs use cyan, yellow, and magenta color filters instead of the traditional red, green, and blue Bayer color filter scheme. In an arrangement referred to as cyan yellow yellow magenta (CYYM), 50% of the color filters are yellow, while 25% are cyan and 25% are magenta. Some filters also add a fourth green filter to the three cyan, yellow, and magenta filters, together referred to as a cyan yellow green magenta (CYGM) filter. Some CFAs use red, green, blue and “emerald” or cyan, referred to as an RGBE color scheme. In some cases, some mix or combination of the Bayer, CYYM, CYGM, or RGBE color schemes may be used. In some cases, color filters of one or more of the colors of the Bayer, CYYM, CYGM, or RGBE color schemes may be omitted, in some cases leaving only two colors or even one color. While the legend 210 of FIG. 2B lists precisely three color filters 212, 214, and 216, and provides green, red, and blue as examples to adhere to the traditional Bayer filter color scheme, it should be understood that more than three colors or less than three colors may alternately be used in the CFA, and that the colors may vary, for example including red, green, blue, cyan, magenta, yellow, emerald, white (transparent), or some combination thereof. Some image sensors, such as the Foveon X3® sensor, may lack color filters altogether, instead opting to use different photodiodes throughout the pixel array (optionally vertically stacked), the different photodiodes having different spectral sensitivity curves and therefore responding to different wavelengths of light. Monochrome image sensors may also lack color filters and therefore lack color depth. Use of color filters in an image sensor used with the camera systems described further herein should therefore be considered optional.

The pixel array 200 of FIG. 2A is illustrated with two pixels that are used for phase detection auto focus (PDAF), which are referred to herein as focus pixels, but may alternately be referred to as PDAF pixels or phase detection (PD) pixels. Other pixels not used for PDAF may simply be referred to as imaging pixels 204. In the pixel array 200 of FIG. 2A, any pixel without a mask 220 is an imaging pixel 204, even though only two imaging pixels 204 are specifically labeled. While two focus pixels are illustrated in the pixel array 200 of FIG. 2A, both in the same column but with three rows of imaging pixels in between, a different pixel array (not pictured) may have any number of focus pixels (i.e., one or more focus pixels), which may be arranged in any possible pattern or arrangement. In some cases, patterns of focus pixels may repeat across a pixel array, for example in “tiles” that are 8 pixels by 8 pixels in size, or 16 pixels by 16 pixels in size.

The two focus pixels illustrated in FIG. 2A are both partially covered by masks 220, the two masks 220 labeled as mask 202A and mask 202B, respectively. Each of the masks 220 may be a mask or shield made of an opaque and/or reflective material, such as a metal. Each mask 220 limits the amount and direction of light that strikes the photodiode of the focus pixel that is partially covered by the mask. The mask 202A and mask 202B each limit how much light reaches and strikes the underlying focus pixel photodiode from a particular direction, and are disposed over two different focus pixel diodes in an opposite direction to produce a pair of left and right images. For example, the mask 202A is disposed over a left side of a first focus pixel, leaving the right side of that first focus pixel to receive light entering from the right side (the right image). The mask 202B is disposed over a right side of a second focus pixel, leaving the left side of that second focus pixel to receive light entering from the left side (the left image). Because the two focus pixels are both illustrated as half-covered by the masks 220, their focus photodiodes effectively receive 50% of the light that an imaging photodiode (which would not be covered by a mask) in the same location on the pixel array would receive.

Any number of focus pixels may be included in a pixel array of an image sensor. Left and right pairs of focus pixels may be adjacent to one another, or may be spaced apart by one or more imaging pixels 204. The two pixels from a left and right pair of focus pixels may both be in the same row and/or same column of the pixel array, may be in a different row and/or different column, or some combination thereof. While masks 202A and 202B are shown within pixel array 200 as masking left and right portions of the focus pixel photodiodes, this is for exemplary purposes only. Focus pixel masks 220 may instead mask top or bottom portions of the focus pixel photodiodes, thus generating top and bottom images (or “up” and “down” images) from the focus pixel data received by the focus pixels. Like the left and right pairs of focus pixels, top and down pairs of focus pixels may both be in the same row and/or same column of the pixel array, may be in a different row and/or different column, or some combination thereof. A pixel array of an image sensor may have a focus pixel with a mask 220 over a left side of one focus pixel, a mask 220 over a right side of a second focus pixel, a mask 220 over a top side of a third focus pixel, a mask 220 over a bottom side of a fourth focus pixel, and optionally more focus pixels with any of these types of masks 220. Using focus pixels with masks 220 along multiple axes (e.g., left-right pairs of focus pixels as well as top-down pairs of focus pixels) can improve autofocus quality. One reason why autofocus quality can be improved by using focus pixels with masks 220 along multiple axes is because use of masks 220 along left and right sides of focus pixel photodiodes alone for PDAF can lead to poor focus on scenes or subjects with many horizontal edges (i.e., lines that appear along a left-right axis relative to the orientation of the focus pixels and masks 220), and use of masks 220 along top and bottom sides of focus pixel photodiodes alone for PDAF can lead to poor focus on scenes or subjects with many vertical edges (i.e., lines that appear along an up-down axis relative to the orientation of the focus pixels and masks 220).

Some PDAF camera systems do not use masks 220 on focus pixels as in FIG. 2A, but instead cover multiple pixels under a single microlens, which may alternately be referred to as an on-chip lens (OCL). FIG. 2C illustrates a top-down view of a pixel array configuration with two side-by-side focus pixels covered by a 2 pixel by 1 pixel microlens. FIG. 2D illustrates a top-down view of a pixel array configuration with four neighboring focus pixels covered by a 2 pixel by 2 pixel microlens. The pixel arrays 230 and 240 of FIG. 2C and FIG. 2D can also be interpreted based on the legend 210 of FIG. 2B.

Referring to FIGS. 2C and 2D, the 2 pixel by 1 pixel microlens 232 of FIG. 2C and the 2 pixel by 2 pixel microlens 242 of FIG. 2D both span multiple adjacent focus pixels (i.e., the microlenses cover multiple adjacent focus pixel photodiodes), and both can limit the amount and/or direction of light that strikes the focus pixel photodiodes of those focus pixels. The microlens 232 of FIG. 2C covers two horizontally-adjacent focus pixels of a pixel array 230, such that focus pixel data from both focus photodiodes may be generated, with focus pixel data from the left one of the focus pixels (labeled with an “L”) representing light approaching from the left side of the pixel array 230, and focus pixel data from the right one of the focus pixels (labeled with an “R”) representing light approaching from the right side of the pixel array 230. While the microlens 232 is shown within pixel array 230 as spanning left and right adjacent pixels/diodes (e.g., in a horizontal direction), this is for exemplary purposes only. A 2 pixel by 1 pixel microlens 232 may instead span top and bottom adjacent pixels/diodes (e.g., in a vertical direction), thus generating an up and down (or top and bottom) pair of focus photodiodes and corresponding pixel data.

Similarly, the microlens 242 of FIG. 2D covers a 2-pixel by 2-pixel square of four adjacent focus pixels of a pixel array 240, such that focus pixel data from all four photodiodes in the square may be generated. The focus pixel data from the four adjacent focus pixels thus includes focus pixel data from an upper-left pixel (labeled “UL” in FIG. 2D) representing light approaching from the upper-left of the pixel array 240, focus pixel data from an upper-right pixel (labelled “UR” in FIG. 2D) representing light approaching from the upper-right of the pixel array 240, focus pixel data from a bottom-left pixel (labeled “BL” in FIG. 2D) representing light approaching from the bottom-left of the pixel array 240, and focus pixel data from a bottom right pixel (labeled “BR” in FIG. 2D) representing light approaching from the bottom right of the pixel array 240. The configurations of pixel arrays 230 and 240 of FIG. 2C and FIG. 2D are exemplary; any number of focus pixels may be included within a pixel array, and may include one or more horizontally-oriented (left-right) 2-pixel by 1-pixel microlenses 232, one or more vertically-oriented (up-down) 2-pixel by 1-pixel microlenses 232, one or more 2-pixel by 2-pixel microlenses 242, or different combinations thereof.

Again referring to FIGS. 2C and 2D, once the pixel array captures a frame, thus capturing focus pixel data for each focus pixel, focus pixel data from paired focus pixels May be compared with one another. For example, focus pixel data from a left focus pixel photodiode may be compared with focus pixel data from a right focus pixel photodiode, and focus pixel data from a top focus pixel photodiode may be compared with focus pixel data from a bottom focus pixel photodiode. If the compared focus pixel data values differ, this difference is known as the phase disparity, also known as the phase difference, defocus value, or separation error. Focus pixels under a 2-pixel by 2-pixel microlens 242 as in FIG. 2D essentially have two vertically-adjacent horizontally-oriented pairs of focus pixels and/or two horizontally-adjacent vertically-oriented pairs of focus pixels. Thus, the focus pixel data from the UL focus pixel may be compared to focus pixel data from the BL focus pixel (as a top/bottom pair), focus pixel data from the UR focus pixel may be compared to focus pixel data from the BR focus pixel (as a top/bottom pair), focus pixel data from the UL focus pixel may be compared to focus pixel data from the UR focus pixel (as a left/right pair), focus pixel data from the BL focus pixel may be compared to focus pixel data from the BR focus pixel (as a left/right pair), or some combination thereof. In some cases, focus pixel data may alternately or additionally be compared between pixels that are opposite each other diagonally (along two axes). For example, focus pixel data from the UL focus pixel focus may be compared to focus pixel data from the BR focus pixel, and/or focus pixel data from the BL focus pixel focus may be compared to focus pixel data from the UR focus pixel.

While the focus pixels under the 2 pixel by 1 pixel microlens 232 of FIG. 2C and the focus pixels under the 2 pixel by 2 pixel microlens 242 of FIG. 2D are all illustrated having the color filter 212 of the first color, this is not required. In some cases, the normal pattern of the CFA of the pixel array may continue under a 2 pixel by 1 pixel microlens 232 and/or under a 2 pixel by 2 pixel microlens 242.

FIG. 2E illustrates a top-down view of a pixel array configuration of an image sensor in which at least one focus pixel has two photodiodes. In particular, a four-pixel by four-pixel pixel array 250 with four focus pixels is illustrated in FIG. 2E. The four focus pixels illustrated in the pixel array 250 each include two photodiodes, with the left-side photodiode and the right-side photodiode of each focus pixel's photodiode pair labeled “L” and “R,” respectively. Focus pixels with two photodiodes, like the focus pixels of FIG. 2E, are sometimes referred to as dual photodiode (2PD) focus pixels.

One of the 2PD focus pixels of FIG. 2E is labeled as 2PD focus pixel 252. The left-side photodiode (L) of the 2PD focus pixel 252 is labeled “left-side photodiode 254L,” and the right-side photodiode (R) of the 2PD focus pixel 252 is labeled “right-side photodiode 254R.” For each captured frame, the left photodiode 254L and the right photodiode 254R may capture light received by the 2PD focus pixel 252 from different angles. For a given frame, the data captured by the left photodiode 254L may be referred to as the left image or left image data, while the data captured by the right photodiode 254R may be referred to as the right image or right image data. The left image data and the right image data may be compared to determine phase disparity.

The pixel array 250 illustrated in FIG. 2E is a “sparse” 2PD pixel array in which only some of the pixels in the pixel array 250 include two photodiodes (namely, the focus pixels). The remaining pixels are imaging pixels and only include a single photodiode. In some cases, however a “dense” 2PD pixel array may be used instead, in which every pixel in the pixel array (or a higher percentage of pixels in the pixel array) include two photodiodes, and can in some cases act as both focus pixels and imaging pixels simultaneously, or can switch between acting as a focus pixel for one frame and acting as an imaging pixel for another frame. While all of the 2PD focus pixels of FIG. 2E are shown as “horizontal” 2PD focus pixels having a left photodiode and a right photodiode, this arrangement is exemplary. A pixel array with 2PD focus pixels may additionally or alternately include “vertical” focus pixels with a top (“up”) photodiode and a bottom (“down”) photodiode and/or photodiodes that are arranged diagonally with respect to one another. Since use of only horizontal focus pixels can sometimes limit recognition of horizontal edges in images, and use of only vertical focus pixels can sometimes limit recognition of vertical edges in images, use of both horizontal focus pixels and vertical focus pixels can improve focus quality by performing well even in images with many horizontal edges and/or vertical edges.

FIG. 2F illustrates a top-down view of a pixel array configuration of an image sensor in which at least one focus pixel has four photodiodes. The pixel array 260 illustrated in FIG. 2F includes focus pixels in which each focus pixel includes four diodes, generally referred to as 4PD focus pixels or Quadrature Phase Detection (QPD) focus pixels. For example, a 4PD focus pixel 262 is labeled in FIG. 2F, and includes an upper-left photodiode labeled with the letters “UL,” an upper-right photodiode labeled with the letters “UR,” a bottom-left photodiode labeled with the letters “BL,” and a bottom-right photodiode labeled with the letters “BR.” Data from each photodiode of the 4PD focus pixel 262 may be compared to data from an adjacent photodiode of the 4PD focus pixel 262 to determine phase difference. For example, photodiode data from the UL photodiode may be compared to photodiode data from the BL photodiode (as a top/bottom pair), photodiode data from the UR photodiode may be compared to photodiode data from the BR photodiode (as a top/bottom pair), photodiode data from the UL photodiode may be compared to photodiode data from the UR photodiode (as a left/right pair), photodiode data from the BL photodiode may be compared to photodiode data from the BR photodiode (as a left/right pair), or some combination thereof. In some cases, photodiode data from the 4PD focus pixel 262 may alternately or additionally be compared between photodiodes that are opposite each other diagonally (along two axes). For example, photodiode data from the UL photodiode of the 4PD focus pixel 262 may be compared to photodiode data from the BR photodiode of the 4PD focus pixel 262, and/or photodiode data from the BL photodiode of the 4PD focus pixel 262 may be compared to photodiode data from the UR photodiode of the 4PD focus pixel 262.

The pixel array 260 illustrated in FIG. 2F is a “sparse” 4PD pixel array in which only some of the pixels in the pixel array 260 include four photodiodes (namely, the focus pixels). The remaining pixels are imaging pixels and only include a single photodiode. In some cases, however a “dense” 4PD pixel array may be used instead, in which every pixel in the pixel array (or a higher percentage of pixels in the pixel array) include four photodiodes, and can in some cases act as both focus pixels and imaging pixels simultaneously, or can switch between acting as a focus pixel for one frame and acting as an imaging pixel for another frame. While all of the 4PD focus pixels of FIG. 2F are shown as “horizontal” 4PD focus pixels having a left photodiode and a right photodiode, this arrangement is exemplary. A pixel array with 4PD focus pixels may additionally or alternately include “vertical” focus pixels with a top (“up”) photodiode and a bottom (“down”) photodiode and/or photodiodes that are arranged diagonally with respect to one another. Since use of only horizontal focus pixels can sometimes limit recognition of horizontal edges in images, and use of only vertical focus pixels can sometimes limit recognition of vertical edges in images, use of both horizontal focus pixels and vertical focus pixels can improve focus quality by performing well even in images with many horizontal edges and/or vertical edges.

In some cases, a pixel array may use some combination of one or more pairs of focus pixels with masks 220 (as illustrated in FIG. 2A), one or more pairs of focus pixels covered by 2-pixel by 1-pixel microlenses 232 (as illustrated in FIG. 2C), one or more groups of focus pixels covered by 2-pixel by 2-pixel microlenses 242 (as illustrated in FIG. 2D), one or more 2PD focus pixels 252 (as illustrated in FIG. 2E), and/or one or more 4PD focus pixels 262 (as illustrated in FIG. 2F). In some cases, focus pixels in any of the configurations illustrated in and discussed with respect to FIG. 2A-2F may be arranged in a vertically and/or horizontally tiled pattern, such as the tiled patterns of the 2PD and 4PD focus pixels of FIG. 2E and FIG. 2F.

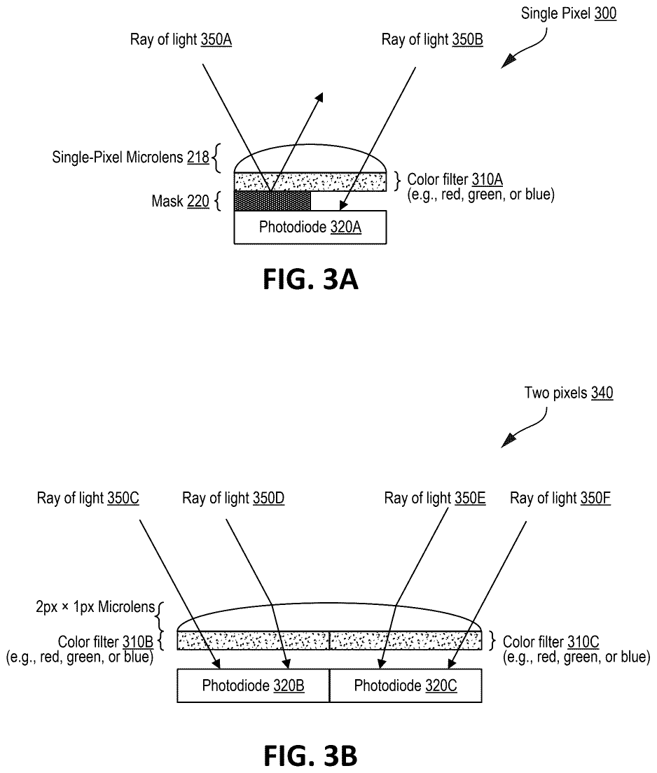

FIG. 3A illustrates a side view of a single pixel of a pixel array of an image sensor that is partially covered with a mask. The side view of the pixel 300 illustrates the single-pixel microlens 218 over a color filter 310A, which is over a mask 220, the mask 220 covering the left side of the photodiode 320A. A ray of light 350B entering from the right side of the microlens 218 passes through the color filter 310A and reaches the photodiode 320A, while ray of light 350A entering from the left side of the microlens 218 is reflected by the mask 220. While a similar pixel with the mask 220 over the right side of the photodiode 320A is not illustrated, it should be understood that this could be achieved by horizontally flipping the illustration of FIG. 3A. In an alternate embodiment, the mask 220 may be positioned above the color filter 310A and/or above the microlens 218.

FIG. 3B illustrates a side view of two pixels of a pixel array of an image sensor, the two pixels covered by a 2 pixel by 1 pixel microlens. The side view of the two pixels 340 of FIG. 3B illustrates the 2 pixel by 1 pixel microlens 232 over one color filter 310B on the left and another adjacent color filter 310C on the right, with the color filter 310B on the left over a left photodiode 320B, and the color filter 310C on the right over a right photodiode 320C. Two rays of light 350C and 350D entering from the left side of the microlens 232 pass through the left color filter 310B and reach the left photodiode 320B, while two rays of light 350E and 350F entering from the right side of the microlens 232 pass through the right color filter 310C and reach the right photodiode 320C.

Each color filter of the color filters 310A, 310B, and 310C of FIG. 3A and FIG. 3B may be a color filter of any color previously described with respect to color filters 212, 214, and 216. That is, while FIG. 3A and FIG. 3B list red, green, and blue as example colors to adhere to the traditional Bayer color scheme, each color filter of the color filters 310A, 310B, and 310C may represent another color such as cyan, yellow, magenta, emerald, or white (transparent). While the color filters 310A, 310B, and 310C all are illustrated with an identical pattern in FIG. 3A and FIG. 3B, the pattern matching the pattern of color filter 212 of FIGS. 2A-2D, the three color filters 310A, 310B, and 310C need not all represent the same color of color filter as each other, and need not represent the same color as the color filter 212 of FIGS. 2A-2D. All three color filters 310A, 310B, and 310C can be different colors, or alternately any two (or all three) can optionally share a color. Alternatively, no color filter may be included.

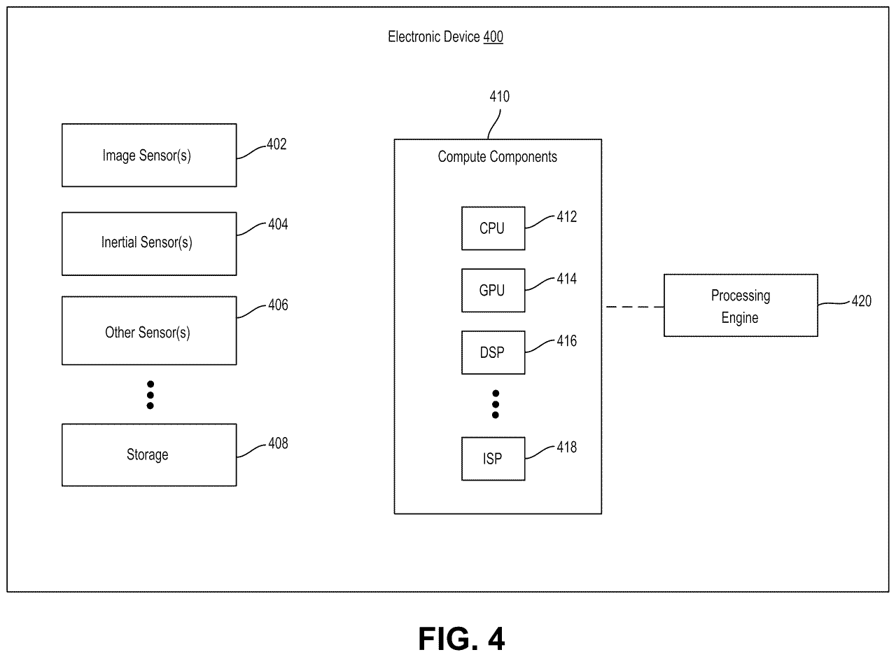

FIG. 4 is a diagram illustrating an example electronic device 400, in accordance with some examples of the disclosure. The electronic device 400 can implement the systems and techniques disclosed herein. For example, in some cases, the electronic device 400 can perform robust motion estimation with depth information.

The electronic device 400 can also perform various tasks and operations such as, for example and without limitation, extended reality (e.g., augmented reality, virtual reality, mixed reality, virtual reality with pass-through video, and/or the like) tasks and operations (e.g., tracking, mapping, localization, content rendering, pose estimation, object detection/recognition, etc.), image/video processing and/or post-processing, data processing and/or post-processing, computer graphics, machine vision, object modeling and registration, multimedia rendering and/or composition, object detection, object recognition, localization, scene recognition, and/or any other data processing tasks, effects, and/or computations.

In the example shown in FIG. 4, the electronic device 400 includes one or more image sensors 402, one or more inertial sensors 404 (e.g., one or more inertial measurement units, etc.), one or more other sensors 406 (e.g., one or more radio detection and ranging (radar) sensors, light detection and ranging (LIDAR) sensors, acoustic/sound sensors, infrared (IR) sensors, magnetometers, touch sensors, laser rangefinders, light sensors, proximity sensors, motion sensors, active pixel sensors, machine vision sensors, ultrasonic sensors, etc.), storage 408, compute components 410, and a processing engine 420. In some cases, the processing engine 420 can include one or more engines such as, for example and without limitation, one or more motion estimation engines, one or more image processing engines, one or more image frontends (e.g., one or more image pre-processing engines), one or more video analytics engines, one or more machine learning engines, one or more image post-processing engines, one or more rendering engines, etc. In some examples, the electronic device 400 can include additional software and/or software engines such as, for example, an extended reality (XR) application, a camera application, a video gaming application, a video conferencing application, etc.

The components 402 through 420 shown in FIG. 4 are non-limiting examples provided for illustration and explanation purposes. In other examples, the electronic device 400 can include more, less, and/or different components than those shown in FIG. 4. For example, in some cases, the electronic device 400 can include one or more display devices, one more other processing engines, one or more receivers (e.g., global positioning systems, global navigation satellite systems, etc.), one or more communications devices (e.g., radio frequency (RF) interfaces and/or any other wireless/wired communications receivers/transmitters), one or more other hardware components, and/or one or more other software and/or hardware components that are not shown in FIG. 4.

The one or more image sensors 402 can include any number of image sensors. For example, the one or more image sensors 402 can include a single image sensor, two image sensors in a dual-camera implementation, or more than two image sensors in other, multi-camera implementations. The electronic device 400 can be part of, or implemented by, a single computing device or multiple computing devices. In some examples, the electronic device 400 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a smart television, a display device, a gaming console, a video streaming device, an IoT (Internet-of-Things) device, a smart wearable device (e.g., a head-mounted display (HMD), smart glasses, etc.), or any other suitable electronic device(s).

In some implementations, the one or more image sensors 402, one or more inertial sensor(s) 404, the other sensor(s) 406, storage 408, compute components 410, and processing engine 420 can be part of the same computing device. For example, in some cases, the one or more image sensors 402, one or more inertial sensor(s) 404, one or more other sensor(s) 406, storage 408, compute components 410, and processing engine 420 can be integrated into a smartphone, laptop, tablet computer, smart wearable device, gaming system, and/or any other computing device. In other implementations, the one or more image sensors 402, one or more inertial sensor(s) 404, the other sensor(s) 406, storage 408, compute components 410, and processing engine 420 can be part of two or more separate computing devices. For example, in some cases, some of the components 402 through 420 can be part of, or implemented by, one computing device and the remaining components can be part of, or implemented by, one or more other computing devices.

The one or more image sensors 402 can include one or more image sensor. In some examples, the one or more image sensors 402 can include any image and/or video sensors or capturing devices, such as a digital camera sensor, a video camera sensor, a smartphone camera sensor, an image/video capture device on an electronic apparatus such as a television or computer, a camera, etc. In some cases, the one or more image sensors 402 can be part of a multi-camera system or a computing device such as an extended reality (XR) device (e.g., an HMD, smart glasses, etc.), a digital camera system, a smartphone, a smart television, a game system, etc. The one or more image sensors 402 can capture image and/or video content (e.g., raw image and/or video data), which can be processed by the compute components 410.

In some examples, the one or more image sensors 402 can capture image data and generate frames based on the image data and/or provide the image data or frames to the compute components 410 for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

The electronic device 400 can include one or more inertial sensors 404. The one or more inertial sensors 404 can include, for example and without limitation, a gyroscope, an accelerometer, an inertial measurement unit (IMU), and/or any other inertial sensors. The one or more inertial sensors 404 can detect motion (e.g., translational and/or rotational) of the electronic device 400. For example, the one or more inertial sensors 404 can detect a specific force and/or angular rate of the electronic device 400. In some cases, the one or more inertial sensors 404 can detect an orientation of the electronic device 400. The one or more inertial sensors 404 can generate linear acceleration measurements, rotational rate measurements, and/or heading measurements. In some examples, the one or more inertial sensors 404 can be used to measure the pitch, roll, and yaw of the electronic device 400.

The electronic device 400 can optionally include one or more other sensor(s) 406. In some examples, the one or more other sensor(s) 406 can detect and generate other measurements used by the electronic device 400. In some cases, the compute components 410 can use data and/or measurements from the one or more image sensors 402, the one or more inertial sensors 404, and/or the one or more other sensor(s) 406 to track a pose of the electronic device 400. As previously noted, in other examples, the electronic device 400 can also include other sensors, such as a magnetometer, an acoustic/sound sensor, an IR sensor, a machine vision sensor, a smart scene sensor, a radio detection and ranging (RADAR) sensor, a light detection and ranging (LIDAR) sensor, a depth sensor, a light sensor, etc.

The storage 408 can be any storage device(s) for storing data. Moreover, the storage 408 can store data from any of the components of the electronic device 400. For example, the storage 408 can store data from the one or more image sensors 402 (e.g., image or video data), data from the one or more inertial sensors 404 (e.g., measurements), data from the one or more other sensors 406 (e.g., measurements), data from the compute components 410 (e.g., processing parameters, timestamps, preferences, virtual content, rendering content, scene maps, tracking and localization data, object detection data, configurations, motion vectors, XR application data, recognition data, synchronization data, outputs, etc.), and/or data from the processing engine 420. In some examples, the storage 408 can include a buffer for storing frames and/or other camera data for processing by the compute components 410.

The one or more compute components 410 can include a central processing unit (CPU) 412, a graphics processing unit (GPU) 414, a digital signal processor (DSP) 416, and/or an image signal processor (ISP) 418. The compute components 410 can perform various operations such as camera synchronization, image enhancement, computer vision, graphics rendering, extended reality (e.g., tracking, localization, pose estimation, mapping, content anchoring, content rendering, etc.), image/video processing, sensor processing, recognition (e.g., text recognition, facial recognition, object recognition, feature recognition, tracking or pattern recognition, scene recognition, occlusion detection, etc.), machine learning, filtering, object detection, and any of the various operations described herein. In the example shown in FIG. 4, the compute components 410 can implement the processing engine 420. For example, the operations for the processing engine 420 can be implemented by any of the compute components 410. The processing engine 420 can include one or more neural network models, such as the unsupervised learning models described herein. In some examples, the compute components 410 can also implement one or more other processing engines.

While the electronic device 400 is shown to include certain components, one of ordinary skill will appreciate that the electronic device 400 can include more or fewer components than those shown in FIG. 4. For example, the electronic device 400 can also include, in some instances, one or more memory devices (e.g., RAM, ROM, cache, and/or the like), one or more network interfaces (e.g., wired and/or wireless communications interfaces and the like), one or more display devices, and/or other hardware or processing devices that are not shown in FIG. 4.

In some examples, the electronic device 400 can implement one or more algorithms for estimating a global motion associated with the electronic device 400 and/or local motion associated with frames captured by the one or more image sensors 402 of the electronic device 400. Moreover, the electronic device 400 can implement the systems and techniques described herein to reduce a power consumption of the electronic device 400 when estimating global and/or local motion. In some cases, the electronic device 400 can shutdown or disable a motion estimation processing pipeline implemented by a video analytics engine when an amount of motion detected, estimated, and/or predicted by the video analytics engine is below a threshold. In such examples, the electronic device 400 can rely on global motion vectors, such as global motion vectors estimated using a Harris corner detection (HCD) algorithm and/or a similar algorithm, to calculate an image transform matrix.

In other examples, such as in intermediate motion cases, when the estimated motion is above a first threshold (referred to as a lower threshold) and below a second threshold (referred to as an upper threshold) that is greater than the first threshold, the electronic device 400 can switch to using an input image with a downscaled resolution based on a computational processing of a temporal filtering indication (TFI). For example, the electronic device 400 can downscale the input image to a lower resolution (e.g., downscaled by 4, 8, 16, or any other factor) before running semi-global matching operations on the downscaled input image, thus conserving power of the device. The algorithm implemented by the electronic device 400 can revert to full resolution motion estimation when the motion map processing perceives the need. For example, the algorithm can revert to full resolution motion estimation when the estimated motion is above a threshold (e.g., above the second or upper threshold). In some cases, the algorithm can be fluid and can switch to processing a downscaled image, such as an image downscaled by 16, rather than reverting to global motion estimation (e.g., motion vector estimation using Harris corner detection) depending on an evaluation of an image quality (IQ).

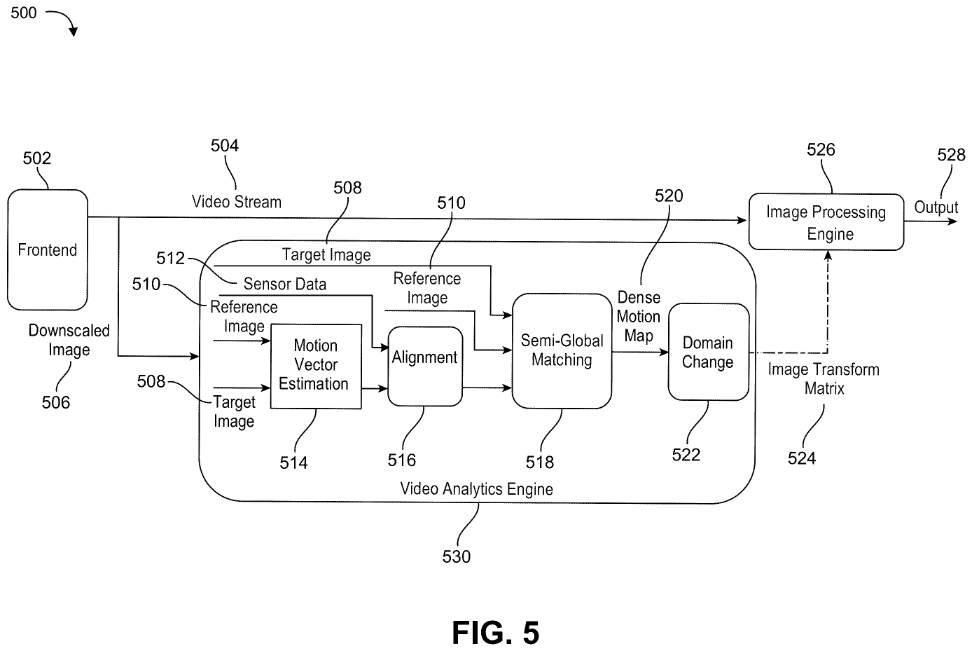

FIG. 5 is a diagram illustrating an example flow 500 for a motion estimation implementation. The example flow 500 shows a pipeline for motion estimation that includes global motion estimation, local motion estimation between image frames, and semi-global matching (SGM).

In this example, the frontend engine 502 downscales an input image from a video stream 504 to generate a downscaled image 506. The frontend engine 502 provides the downscaled image 506 to a video analytics engine 530 for processing. The video analytics engine 530 performs a motion vector estimation 514 using a target image 508 and a reference image 510. In some examples, the target image 508 can be the same as the downscaled image 506 or can be generated based on the downscaled image 506. In some cases, the motion vector estimation 514 can estimate motion vectors using a Harris corner detection algorithm and/or the like. In some examples, the motion vector estimation 514 can estimate a global motion associated with the target image 508, the reference image 510, and/or the electronic device 400. In some cases, prior to processing the target image 508 and the reference image 510, the electronic device 400 can process the target image 508 and the reference image 510 to remove noise from the images.

The motion vector estimation 514 can generate motion vectors for the target image 508. In some examples, the motion vectors can indicate a global motion associated with the target image 508 and/or the electronic device 400. The motion vectors generated by the motion vector estimation 514 can then be processed by an alignment block 516 to account for global motion. In some examples, the alignment block 516 can use sensor data 512 to align the motion vectors generated by the motion vector estimation 514 to account for a global motion associated with the electronic device 400. The sensor data 512 can include one or more measurements obtained by the one or more inertial sensors 404 of the electronic device 400. For example, in some cases, the sensor data 512 can include gyroscope measurements obtained by a gyroscope(s) from the one or more inertial sensors 404. The gyroscope measurements can include an orientation and/or angular velocity of the electronic device 400 measured by the gyroscope(s). The alignment block 516 can use the orientation and/or angular velocity of the electronic device 400 to align the motion vectors generated by the motion vector estimation 514 to account for the global motion of the electronic device 400 (e.g., to account for the orientation and/or angular velocity of the electronic device 400.

In some examples, the alignment block 516 can warp the motion vectors from the motion vector estimation 514 based on the sensor data 512 (e.g., based on the gyroscope measurements, such as the orientation and angular velocity measurements). The alignment block 516 can input the warped motion vectors into an SGM block 518 configured to perform semi-global matching. The SGM block 518 can process the warped motion vectors, the target image 508, and the reference image 510 to generate a dense motion map 520. In some cases, the SGM block 518 can determine a local motion associated with the motion vectors from the motion vector estimation 514. In some examples, the SGM block 518 can compare the target image 508 with the reference image 510 to determine a motion between the target image 508 and the reference image 510. For example, the SGM block 518 can compare the target image 508 with the reference image 510 to determine how a local motion between the target image 508 and the reference image 510.

In some cases, the dense motion map 520 can reflect the local motion between the target image 508 and the reference image 510. In some cases, the dense motion map 520 can reflect the local motion between the target image 508 and the reference image 510 as well as a global motion estimated for the target image 508 and/or the reference image 510. In some examples, the dense motion map 520 can include motion estimates for blocks or regions (e.g., for each block or region) of image data in the target image 508. The blocks or regions of image data can include blocks or regions of pixels of the target image 508. For example, the blocks or regions of image data can include N×N (e.g., 4×4, 8×8, etc.) blocks of pixels. In this example, the dense motion map can include motion estimates for each N×N block of pixels in the targe image 508.

The domain change block 522 can use a global stabilization matrix and the dense motion map 520 to generate a transform matrix 524. For example, the domain change block 522 can warp the dense motion map 520 using a global stabilization matrix to obtain the transform matrix 524. The domain change block 522 can provide the transform matrix 524 to an image processing engine 526, which can use the transform matrix 524 to generate an output 528. For example, the image processing engine 526 can use the transform matrix 524 to perform image stabilization operations on one or more image frames, such as one or more image frames of the video stream 504. To illustrate, the image processing engine 526 can use the transform matrix 524 to stabilize one or more image frames from the video stream 504.

As previously mentioned, an electronic device can process images of a scene to align the images with each other, such as for video coding purposes. The electronic device may use hierarchical motion estimation (HME) to generate an alignment transformation matrix for aligning two images of a scene with each other to improve image quality (IQ) with regards to intensity, brightness, and image sharpness.

In one or more examples, HME is a motion estimation technique which is used to estimate an alignment transformation matrix between two images. HME has been used extensively for alignment purposes in motion-compensated temporal filtering (MCTF), multi-frame noise reduction (MFNR), and high dynamic range (HDR) imaging use-cases. During the process of HME, feature points within an image are computed in coarse resolutions, and refined in fine resolutions. The term “hierarchical” in HME refers to the fact that multi-scale operations are being performed for the motion estimation. The refined feature points can then be used to estimate the alignment transformation matrix.

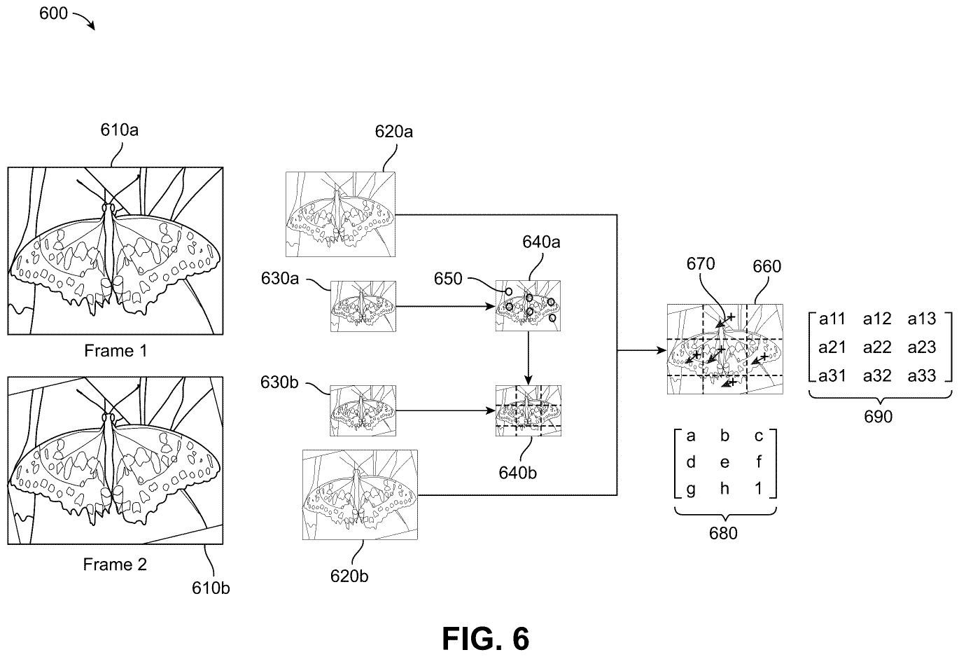

FIG. 6 shows an example of HME for generating an alignment transformation matrix. In particular, FIG. 6 is a diagram illustrating an example of HME 600 to generate an alignment transformation matrix for aligning two images (e.g., a first image 610a and a second image 610b) with each other. In FIG. 6, two images (e.g., the first image 610a and the second image 610b) of a scene including a butterfly are shown to have a first resolution, which is a full scale resolution.

During operation of the process of HME 600, one or more processors of a device (e.g., electronic device 400 of FIG. 4) can downscale the first image 610a and the second image 610b from the first resolution (e.g., a full scale resolution) to a second resolution lower than the first resolution. The second resolution may be a downscale (DS) 4 resolution, a DS 8 resolution, or a DS 16 resolution. In one or more examples, the input images (e.g., the first image 610a and the second image 610b) are downscaled from full scale resolution because otherwise performing HME 600 based on the full scale resolution input images can have large computational requirements that can lead to high latencies and poor power performance.

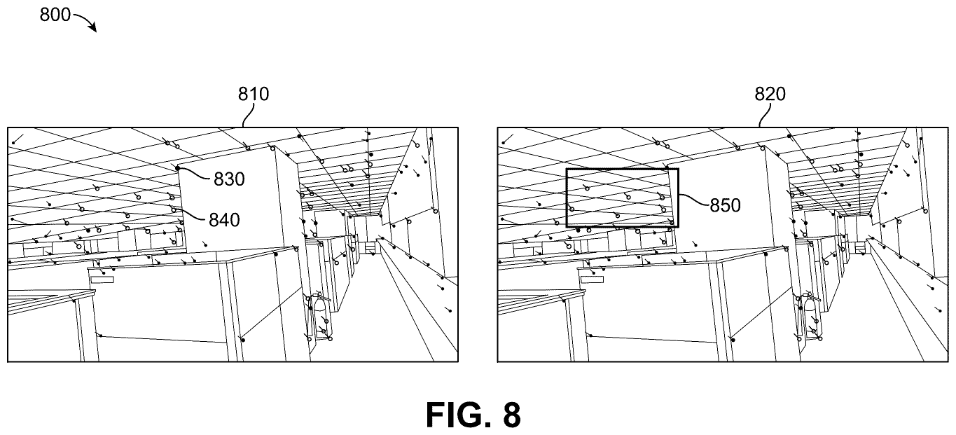

In one or more examples, the first image 610a may be downscaled to generate an image with a DS 4 resolution. In FIG. 8, the first image 610a is shown to be downscaled to generate a first image 620a with a DS 4 resolution. Similarly, the second image 610b may be downscaled to generate an image with a DS 4 resolution. The second image 610b is shown to be downscaled to generate a second image 620b with a DS 4 resolution.

In some examples, the first image 610a may be downscaled to generate an image with a DS 8 resolution or a DS 16 resolution. In FIG. 8, the first image 610a is shown to be downscaled to generate a first image 630a with a DS 8 resolution. Similarly, the second image 610b may be downscaled to generate an image with a DS 8 resolution or a DS 16 resolution. The second image 610b is shown to be downscaled to generate a second image 630b with a DS 8 resolution.

After the first image 610a and the second image 610b are downscaled from the first resolution to the second resolution, the one or more processors can determine (e.g., from the first image 630a with a DS 8 resolution) a plurality of feature points 650 (e.g., as shown in the first image 640a with a DS 8 resolution). In one or more examples, one or more feature points (e.g., located at corners) of the plurality of feature points 650 can be determined based on a Harris Corner Detection (HCD) algorithm. In one or more examples, HCD can be used to identify corner points in an image (e.g., an image frame), which can be used to form a grid of points within the image.

In one or more examples, the one or more processors can determine or qualify (e.g., from the second image 630b with a DS 8 resolution) regions with strong features (e.g., as shown in the second image 640b with a DS 8 resolution). In some examples, the one or more processors can match the regions using normalized cross correlation (NCC). In some examples, the one or more processors can, on an image 660 (e.g., formed from the combination of images 620a and 620b) with a DS 4 resolution, refine the NCC on the regions.

The one or more processors can determine, based on the plurality of feature points 650, a plurality of motion vectors 670 (e.g., shown in the image 660 with a DS 4 resolution) associated with the plurality of feature points 650. In some examples, the plurality of motion vectors 670 can be determined based on NCC. The one or more processors can determine, based on the motion vectors 670, a transformation matrix 680 (e.g., a three by three matrix) with a DS 4 resolution. In one or more examples, the transformation matrix 680 can be determined based on a random sample consensus (RANSAC) algorithm. The one or more processors can upscale the transformation matrix 680 with a DS 4 resolution to generate a transformation matrix 690 (e.g., a three by three matrix) with a full scale resolution for aligning the first image 610a and the second image 610b. In one or more examples, the one or more processors can apply the transformation matrix 690 to a pixel within the first image 610a to determine the location of the same pixel within the second image 610b.

In one or more examples, as mentioned, in cases with multi-depth scenes with only local motion (e.g., movement of one or more objects within a scene) exists, no global motion (e.g., movement caused by motion of the camera), HME can fail to generate proper alignment transformation matrix, which ideally is expected to be a unity transformation matrix. In these cases, HME can generate an inaccurate alignment transformation matrix that can introduce wobbling artifacts in the aligned images. As HME is an image-feature based alignment transform estimation technique, it fails to generate a global transformation matrix for a multi-depth scene that includes global motion. Therefore, improved systems and techniques that provide a robust alignment transformation matrix that reduces artifacts (e.g., wobbling effects) in multi-depth scenes.

In one or more aspects, the systems and techniques provide solutions for robust motion estimation with depth information In one or more examples, systems and techniques provide solutions that address issues with image-based motion estimation in multi-depth and local motion scenarios, which can have large impact on image quality IQ in HDR and video recording use cases. The systems and techniques improve global alignment transformation estimation (e.g., including the estimation of a global alignment transformation matrix) by selecting feature points intelligently in the HME algorithm. In one or more examples, the feature points can be selected from a region (e.g., either a background or a foreground of the scene) which covers the majority of the field of view.

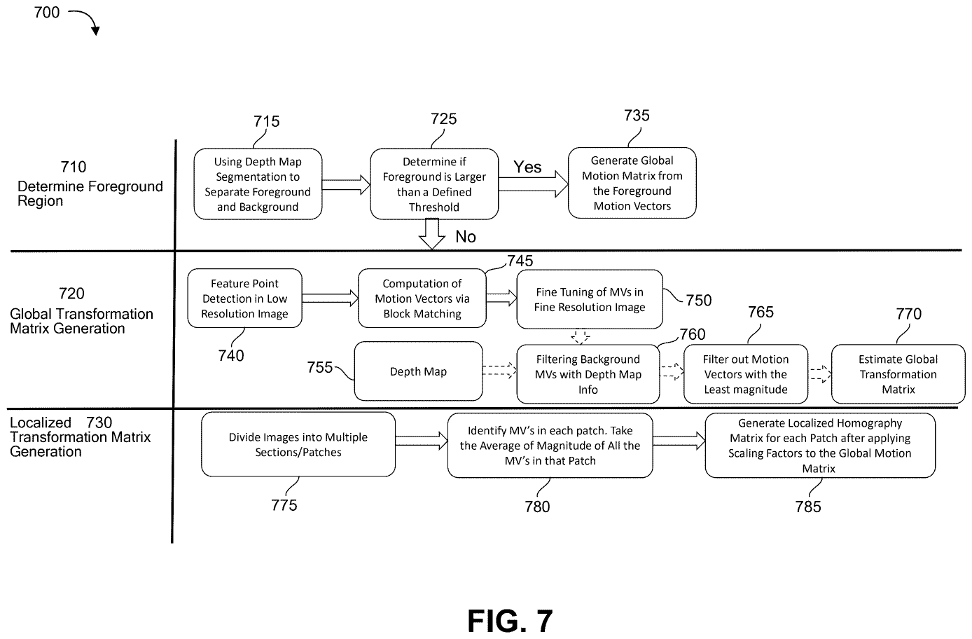

FIG. 7 shows an example process for generating transformation matrices that minimize wobbling artifacts. In particular, FIG. 7 is a flow diagram illustrating an example of a process 700 for robust motion estimation with depth information for generating alignment transformation matrices that minimize artifacts.

During operation of the process 700 for robust motion estimation with depth information of FIG. 7, at section 710, one or more processors of a device (e.g., electronic device 400 of FIG. 4) can determine a foreground (e.g., a foreground region) of a scene. For the determining of the foreground, at block 715, the one or more processors can determine, based on a depth map (e.g., depth map segmentation) for a first image (e.g., first image 610a of FIG. 6 with a full scale resolution or the first image 810 of FIG. 8 with a full scale resolution) of a scene, the foreground of the scene of the first image and a background of the scene of the first image. In one or more examples, the one or more processors can generate, based on the first image, the depth map for the first image based on phase detection autofocus (PDAF) segmentation, contrast detection autofocus (CDAF) segmentation, or stereoscopy depth. PDAF segmentation generally has a high level of accuracy in estimating depth with a very low latency.

At block 725, the one or more processors can determine whether the foreground of the scene of the first image is greater than a threshold area. In one or more examples, the threshold area can be based on a region of interest (ROI) within the scene. If the one or more processors determine that the foreground of the scene of the first image is greater than a threshold area (e.g., Yes), at block 735, the one or more processors can, based on motion vectors of the plurality of motion vectors within the foreground of the scene of the first image, generate a global transformation matrix for aligning the first image (e.g., first image 610a of FIG. 6 with a full scale resolution or the first image 810 of FIG. 8 with a full scale resolution) with a second image (e.g., second image 610b of FIG. 6 with a full scale resolution or the second image 820 of FIG. 8 with a full scale resolution) of the scene. In one or more examples, the global transformation matrix can be determined based on a RANSAC algorithm.

However, if the one or more processors determine that the foreground of the scene of the first image is not greater than (e.g., less than or equal to) the threshold area (e.g., No), the process 700 can proceed to section 720. At section 720, the one or more processors can generate a global transformation matrix (e.g., based on motion vectors located within the background of the scene). For determining the global transformation matrix, at block 740, the one or more processors can determine a plurality of feature points (e.g., feature points 650 in FIG. 6) in a low resolution of the first image (e.g., in the first image 640a with a DS 8 or DS 16 resolution). In one or more examples, one or more feature points of the plurality of feature points can be determined based on an HCD algorithm. In some aspects, the one or more processors can determine the plurality of feature points at block 740 in response to determining that the foreground of the scene of the first image is not greater than (e.g., less than or equal to) the threshold area (e.g., a No decision at block 725).

At block 745, the one or more processors can determine, based on the plurality of feature points (e.g., via block matching), a plurality of motion vectors (e.g., motion vectors 670 of FIG. 6) associated with the plurality of feature points. In some examples, the plurality of motion vectors can be determined based on NCC. At block 750, the one or more processors can fine tune the motion vectors within a fine resolution first image (e.g., the first image 660 with a DS 4 resolution).

At block 755, the one or more processors can generate, based on the first image, a depth map for the first image based on PDAF segmentation, CDAF segmentation, or stereoscopy depth. At block 760, the one or more processors can determine (e.g., filter out), based on the depth map (e.g., depth map information), background motion vectors (e.g., global motion vectors, such as global motion vectors 840 of FIG. 8) of the plurality of motion vectors associated with the background of the scene of the first image. At block 765, the one or more processors can determine (e.g., filter out) motion vectors of the background motion vectors that have a magnitude less than a magnitude threshold. At block 770, the one or more processors can, based on the background motion vectors with a magnitude less than a magnitude threshold, generate a transformation matrix for aligning the background of the first image (e.g., first image 610a of FIG. 6 or first image 810 of FIG. 8) and the background of a second image (e.g., second image 610b of FIG. 6 or second image 820 of FIG. 8). In one or more examples, the transformation matrix can be determined based on a RANSAC algorithm. For an example mathematical representation of the transformation matrix, X_{B} and

$${X}_{B}^{′}$$

can be background feature points in image/(e.g., the first image) and I′ (e.g., the second image), respectively. The linear transformation matrix HB can be estimated by:

$${X}_{B}^{′} = {H}_{B} {X}_{B} .$$

After the transformation matrix for aligning the background of the first image and the background of a second image is generated, the process 700 can proceed to section 730. In section 730, the one or more processors can generate a localized (or local) transformation matrix for aligning a portion (e.g., patch or region) of the foreground of the scene of the first image (e.g., first image 610a of FIG. 6 or first image 810 of FIG. 8) with a corresponding portion (e.g., patch or region) of the foreground of the scene of the second image (e.g., second image 610b of FIG. 6 or second image 820 of FIG. 8). For determining the local transformation matrix, at block 775, the one or more processors can divide the first image and the second image into a plurality of portions (e.g., patches or regions). At block 780, the one or more processors can determine a scaling factor based on a magnitude (e.g., and an orientation) of motion vectors of the plurality of motion vectors within the portion of the foreground of the scene of the first image. In some examples, the scaling factor can be further based on an average of the magnitude of the motion vectors of the plurality of motion vectors within the portion of the foreground of the scene of the first image. At block 785, the one or more processors can scale, based on the scaling factor, the transformation matrix (e.g., generated in block 770) to generate a local transformation matrix for aligning the portion of the foreground of the scene of the first image (e.g., first image 610a of FIG. 6 or first image 810 of FIG. 8) with a corresponding portion of the foreground of the scene of the second image (e.g., second image 610b of FIG. 6 or second image 820 of FIG. 8). In one or more examples, the local transformation matrix can be determined based on a RANSAC algorithm. In one or more examples, motion vectors located in other portions (e.g., patches) of the foreground that have a different orientation than the motion vectors within the portion of the foreground are local motion vectors (e.g., local motion vectors 830 of FIG. 8) and, as such, transformation matrices do not need to be generated for these other portions.

FIG. 8 shows examples of images with global and local motion vectors. In particular, FIG. 8 is a diagram illustrating examples 800 of images (e.g., a first image 810 and a second image 820) showing global motion vectors 830 and local motion vectors 840 within a background and a portion 850 of a foreground of a multi-depth scene. In FIG. 8, the first image 810 is shown to include both global motion vectors 840 (e.g., depicted in green) and local motion vectors 830 (e.g., depicted in red) in the scene. The second image 820 in FIG. 8 is shown to include a portion 850 (e.g., a patch or a region) located within the foreground of the scene.

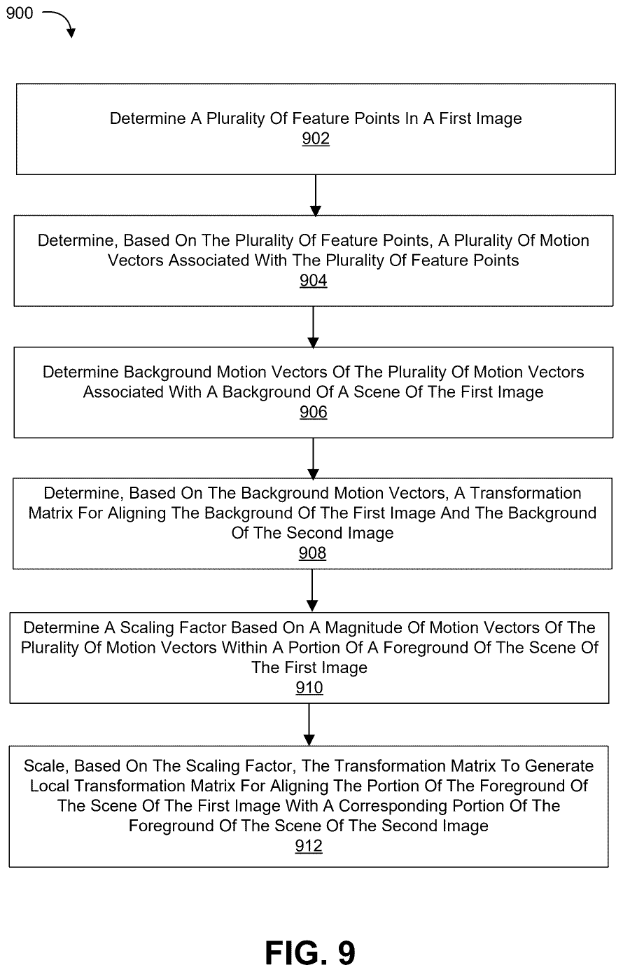

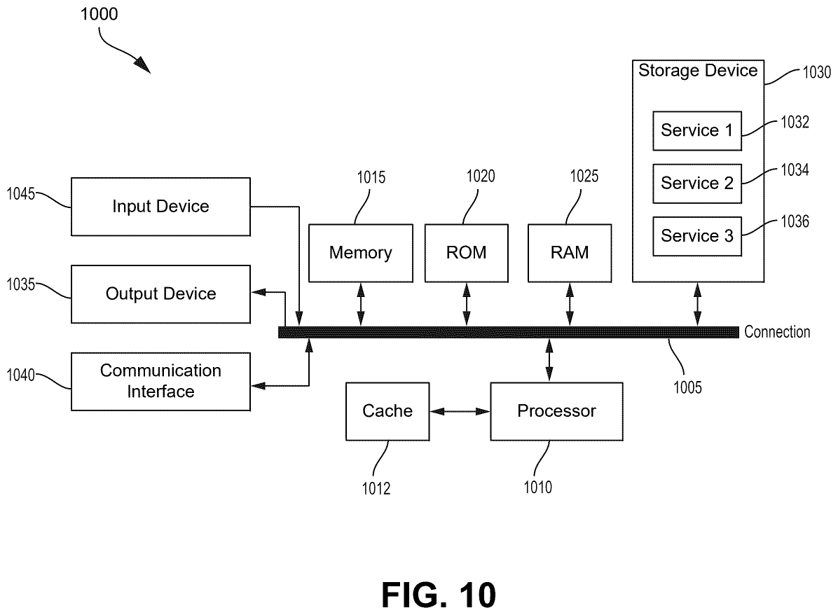

FIG. 9 is a flow chart illustrating an example of a process 900 for robust motion estimation with depth information. The process 900 can be performed by a computing device (e.g., a computing device or computing system 1000 of FIG. 10) or by a component or system (e.g., a chipset, one or more image signal processors (ISPs), host processors (HPs) (or application processors (APs)), central processing units (CPUs), digital signal processors (DSPs), graphics processing units (GPUs), neural processing units (NPUs), any combination thereof, and/or other type of processor(s), or other component or system) of the computing device. The operations of the process 900 may be implemented as software components that are executed and run on one or more processors (e.g., processor 1010 of FIG. 10, or other processor(s)). Further, the transmission and reception of signals by the computing device in the process 900 may be enabled, for example, by one or more antennas and/or one or more transceivers (e.g., wireless transceiver(s)).

At block 902, the computing device (or component thereof) can determine a plurality of feature points in a first image. In some cases, the computing device (or component thereof) can determine the plurality of feature points using a Harris Corner Detection (HCD) algorithm or other algorithm for determining feature points in images (e.g., using a machine learning system such as one or more neural networks, etc.). In some aspects, the computing device (or component thereof) can determine a foreground of a scene of the first image is less than a threshold area. The computing device (or component thereof) can determine, based on determining the foreground of the scene of the first image is less than the threshold area, the plurality of feature points in the first image. For instance, the computing device (or component thereof) can proceed to determine the plurality of feature points (e.g., at block 740 of FIG. 7) in the first image in response to determining the foreground of the scene of the first image is less than the threshold area. For instance, as described above with respect to FIG. 7, one or more processors can determine, at block 725, whether the foreground of the scene of the first image is greater than the threshold area. The one or more processors can determine the plurality of feature points at block 740 in response to determining that the foreground of the scene of the first image is not greater than (e.g., less than or equal to) the threshold area (e.g., a No decision at block 725). In some cases, the threshold area is based on a region of interest. Further, if the one or more processors determine that the foreground of the scene of the first image is not greater than (e.g., less than or equal to) the threshold area (e.g., a No decision at block 725), the process 700 can proceed to section 720, where at section 720, the one or more processors can generate a global transformation matrix (e.g., based on motion vectors located within the background of the scene as described below with respect to blocks 704-712 of FIG. 7). In the process of determining the global transformation matrix, the one or more processors can, at block 740, determine the plurality of feature points (e.g., feature points 650 in FIG. 6), for instance in a low resolution of the first image (e.g., in the first image 640a with a DS 8 or DS 16 resolution).

In some aspects, the computing device (or component thereof) can determine the foreground of a scene of the first image is greater than the threshold area. The computing device (or component thereof) can generate, based on determining the foreground of the scene of the first image is greater than the threshold area, a global transformation matrix based on motion vectors of the plurality of motion vectors within the foreground of the scene of the first image. For example, as described above with respect to FIG. 7, if the one or more processors determine that the foreground of the scene of the first image is greater than the threshold area (e.g., a Yes decision at block 725), the one or more processors can generate, based on motion vectors of the plurality of motion vectors within the foreground of the scene of the first image, a global transformation matrix for aligning the first image (e.g., first image 610a of FIG. 6 with a full scale resolution or the first image 810 of FIG. 8 with a full scale resolution) with a second image (e.g., second image 610b of FIG. 6 with a full scale resolution or the second image 820 of FIG. 8 with a full scale resolution) of the scene.

At block 904, the computing device (or component thereof) can determine, based on the plurality of feature points, a plurality of motion vectors associated with the plurality of feature points. In some aspects, the computing device (or component thereof) can determine the plurality of motion vectors using normalized cross correlation (NCC) or other technique for determining motion vectors (e.g., using optical flow, using a machine learning system such as one or more neural networks, etc.).

At block 906, the computing device (or component thereof) can determine background motion vectors of the plurality of motion vectors associated with a background of a scene of the first image. In some aspects, the computing device (or component thereof) can determine the background motion vectors based on a depth map for the first image.

At block 908, the computing device (or component thereof) can determine, based on the background motion vectors, a transformation matrix for aligning the background of the first image and the background of a second image. In some aspects, prior to determination of the plurality of feature points in the first image, the computing device (or component thereof) can downscale the first image and the second image from a first resolution to a second resolution lower than the first resolution (e.g., as shown in FIG. 6).

At block 910, the computing device (or component thereof) can determine a scaling factor based on a magnitude of motion vectors of the plurality of motion vectors within a portion of the foreground of the scene of the first image. In some aspects, to determine the scaling factor, the computing device (or component thereof) can determine an average of the magnitude of the motion vectors of the plurality of motion vectors within the portion of the foreground of the scene of the first image. In some aspects, the computing device (or component thereof) can determine, based on the depth map for the first image, the foreground of the scene of the first image and the background of the scene of the first image (e.g., as described with respect to FIG. 7). For instance, in some cases, the computing device (or component thereof) can generate, based on the first image, the depth map for the first image based on phase detection autofocus (PDAF) segmentation, contrast detection autofocus (CDAF) segmentation, stereoscopy depth, any combination thereof, and/or using other techniques.

At block 912, the computing device (or component thereof) can scale, based on the scaling factor, the transformation matrix to generate a local transformation matrix for aligning the portion of the foreground of the scene of the first image with a corresponding portion of the foreground of the scene of the second image. In some aspects, the computing device (or component thereof) can determine the transformation matrix using a random sample consensus (RANSAC) algorithm. In some cases, the computing device (or component thereof) can align the portion of the foreground of the scene of the first image with the corresponding portion of the foreground of the scene of the second image using the local transformation matrix.

In some cases, the computing device of process 900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed for robust motion estimation with depth information. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for aligning images, the apparatus comprising: at least one memory; and at least one processor coupled to the at least one memory and configured to: determine a plurality of feature points in a first image; determine, based on the plurality of feature points, a plurality of motion vectors associated with the plurality of feature points; determine background motion vectors of the plurality of motion vectors associated with a background of a scene of the first image; determine, based on the background motion vectors, a transformation matrix for aligning the background of the first image and the background of a second image; determine a scaling factor based on a magnitude of motion vectors of the plurality of motion vectors within a portion of a foreground of the scene of the first image; and scale, based on the scaling factor, the transformation matrix to generate a local transformation matrix for aligning the portion of the foreground of the scene of the first image with a corresponding portion of the foreground of the scene of the second image.

Aspect 2. The apparatus of Aspect 1, wherein the at least one processor is configured to determine, based on a depth map for the first image, the foreground of the scene of the first image and the background of the scene of the first image.

Aspect 3. The apparatus of Aspect 2, wherein the at least one processor is configured to generate, based on the first image, the depth map for the first image based on phase detection autofocus (PDAF) segmentation, contrast detection autofocus (CDAF) segmentation, or stereoscopy depth.

Aspect 4. The apparatus of any of Aspects 1 to 3, wherein the at least one processor is configured to: determine the foreground of a scene of the first image is less than a threshold area; and determine, based on determining the foreground of the scene of the first image is less than the threshold area, the plurality of feature points in the first image.

Aspect 5. The apparatus of Aspect 4, wherein the threshold area is based on a region of interest.

Aspect 6. The apparatus of any of Aspects 1 to 5, wherein the at least one processor is configured to, prior to determination of the plurality of feature points in the first image, downscale the first image and the second image from a first resolution to a second resolution lower than the first resolution.

Aspect 7. The apparatus of any of Aspects 1 to 6, wherein the at least one processor is configured to determine the plurality of feature points using a Harris Corner Detection (HCD) algorithm.

Aspect 8. The apparatus of any of Aspects 1 to 7, wherein the at least one processor is configured to determine the plurality of motion vectors using normalized cross correlation (NCC).

Aspect 9. The apparatus of any of Aspects 1 to 8, wherein the at least one processor is configured to determine the background motion vectors based on a depth map for the first image.

Aspect 10. The apparatus of any of Aspects 1 to 9, wherein, to determine the scaling factor, the at least one processor is configured to determine an average of the magnitude of the motion vectors of the plurality of motion vectors within the portion of the foreground of the scene of the first image.

Aspect 11. The apparatus of any of Aspects 1 to 10, wherein the at least one processor is configured to determine the transformation matrix using a random sample consensus (RANSAC) algorithm.

Aspect 12. The apparatus of any of Aspects 1 to 11, wherein the at least one processor is configured to: determine the foreground of a scene of the first image is greater than a threshold area; and generate, based on determining the foreground of the scene of the first image is greater than the threshold area, a global transformation matrix based on motion vectors of the plurality of motion vectors within the foreground of the scene of the first image.

Aspect 13. A method of aligning images, the method comprising: determining a plurality of feature points in a first image; determining, based on the plurality of feature points, a plurality of motion vectors associated with the plurality of feature points; determining background motion vectors of the plurality of motion vectors associated with a background of a scene of the first image; determining, based on the background motion vectors, a transformation matrix for aligning the background of the first image and the background of a second image; determining a scaling factor based on a magnitude of motion vectors of the plurality of motion vectors within a portion of a foreground of the scene of the first image; and scaling, based on the scaling factor, the transformation matrix to generate a local transformation matrix for aligning the portion of the foreground of the scene of the first image with a corresponding portion of the foreground of the scene of the second image.

Aspect 14. The method of Aspect 13, further comprising determining, based on a depth map for the first image, the foreground of the scene of the first image and the background of the scene of the first image.

Aspect 15. The method of Aspect 14, further comprising generating, based on the first image, the depth map for the first image based on phase detection autofocus (PDAF) segmentation, contrast detection autofocus (CDAF) segmentation, or stereoscopy depth.

Aspect 16. The method of any of Aspects 13 to 15, further comprising: determining the foreground of a scene of the first image is less than a threshold area; and determining, based on determining the foreground of the scene of the first image is less than the threshold area, the plurality of feature points in the first image.

Aspect 17. The method of Aspect 16, wherein the threshold area is based on a region of interest.

Aspect 18. The method of any of Aspects 13 to 17, further comprising, prior to determining the plurality of feature points in the first image, downscaling the first image and the second image from a first resolution to a second resolution lower than the first resolution.

Aspect 19. The method of any of Aspects 13 to 18, wherein the plurality of feature points are determined based on a Harris Corner Detection (HCD) algorithm.

Aspect 20. The method of any of Aspects 13 to 19, wherein the plurality of motion vectors are determined based on normalized cross correlation (NCC).

Aspect 21. The method of any of Aspects 13 to 20, wherein the background motion vectors are determined based on a depth map for the first image.

Aspect 22. The method of any of Aspects 13 to 21, wherein the scaling factor is further based on an average of the magnitude of the motion vectors of the plurality of motion vectors within the portion of the foreground of the scene of the first image.

Aspect 23. The method of any of Aspects 13 to 22, wherein the transformation matrix is determined based on a random sample consensus (RANSAC) algorithm.

Aspect 24. The method of any of Aspects 13 to 23, further comprising: determining the foreground of a scene of the first image is greater than a threshold area; and generating, based on determining the foreground of the scene of the first image is greater than the threshold area, a global transformation matrix based on motion vectors of the plurality of motion vectors within the foreground of the scene of the first image.

Aspect 25. A non-transitory computer-readable medium having stored thereon instructions that, when executed by at least one processor, cause the at least one processor to perform operations according to any of Aspects 13 to 24.

Aspect 26. An apparatus for aligning images, the apparatus including one or more means for performing operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for aligning images, the apparatus comprising:
at least one memory; and
at least one processor coupled to the at least one memory and configured to:
determine a plurality of feature points in a first image;
determine, based on the plurality of feature points, a plurality of motion vectors associated with the plurality of feature points;
determine background motion vectors of the plurality of motion vectors associated with a background of a scene of the first image;
determine, based on the background motion vectors, a transformation matrix for aligning the background of the first image and the background of a second image;
determine a scaling factor based on a magnitude of motion vectors of the plurality of motion vectors within a portion of a foreground of the scene of the first image; and
scale, based on the scaling factor, the transformation matrix to generate a local transformation matrix for aligning the portion of the foreground of the scene of the first image with a corresponding portion of the foreground of the scene of the second image.

2. The apparatus of claim 1, wherein the at least one processor is configured to determine, based on a depth map for the first image, the foreground of the scene of the first image and the background of the scene of the first image.

3. The apparatus of claim 2, wherein the at least one processor is configured to generate, based on the first image, the depth map for the first image based on phase detection autofocus (PDAF) segmentation, contrast detection autofocus (CDAF) segmentation, or stereoscopy depth.

4. The apparatus of claim 1, wherein the at least one processor is configured to:
determine the foreground of a scene of the first image is less than a threshold area; and
determine, based on determining the foreground of the scene of the first image is less than the threshold area, the plurality of feature points in the first image.

5. The apparatus of claim 4, wherein the threshold area is based on a region of interest.

6. The apparatus of claim 1, wherein the at least one processor is configured to, prior to determination of the plurality of feature points in the first image, downscale the first image and the second image from a first resolution to a second resolution lower than the first resolution.

7. The apparatus of claim 1, wherein the at least one processor is configured to determine the plurality of feature points using a Harris Corner Detection (HCD) algorithm.

8. The apparatus of claim 1, wherein the at least one processor is configured to determine the plurality of motion vectors using normalized cross correlation (NCC).

9. The apparatus of claim 1, wherein the at least one processor is configured to determine the background motion vectors based on a depth map for the first image.

10. The apparatus of claim 1, wherein, to determine the scaling factor, the at least one processor is configured to determine an average of the magnitude of the motion vectors of the plurality of motion vectors within the portion of the foreground of the scene of the first image.

11. The apparatus of claim 1, wherein the at least one processor is configured to determine the transformation matrix using a random sample consensus (RANSAC) algorithm.

12. The apparatus of claim 1, wherein the at least one processor is configured to:
determine the foreground of a scene of the first image is greater than a threshold area; and
generate, based on determining the foreground of the scene of the first image is greater than the threshold area, a global transformation matrix based on motion vectors of the plurality of motion vectors within the foreground of the scene of the first image.

13. A method of aligning images, the method comprising:
determining a plurality of feature points in a first image;
determining, based on the plurality of feature points, a plurality of motion vectors associated with the plurality of feature points;
determining background motion vectors of the plurality of motion vectors associated with a background of a scene of the first image;
determining, based on the background motion vectors, a transformation matrix for aligning the background of the first image and the background of a second image;
determining a scaling factor based on a magnitude of motion vectors of the plurality of motion vectors within a portion of a foreground of the scene of the first image; and
scaling, based on the scaling factor, the transformation matrix to generate a local transformation matrix for aligning the portion of the foreground of the scene of the first image with a corresponding portion of the foreground of the scene of the second image.

14. The method of claim 13, further comprising determining, based on a depth map for the first image, the foreground of the scene of the first image and the background of the scene of the first image.

15. The method of claim 14, further comprising generating, based on the first image, the depth map for the first image based on phase detection autofocus (PDAF) segmentation, contrast detection autofocus (CDAF) segmentation, or stereoscopy depth.

16. The method of claim 13, further comprising:
determining the foreground of a scene of the first image is less than a threshold area; and
determining, based on determining the foreground of the scene of the first image is less than the threshold area, the plurality of feature points in the first image.

17. The method of claim 13, further comprising, prior to determining the plurality of feature points in the first image, downscaling the first image and the second image from a first resolution to a second resolution lower than the first resolution.

18. The method of claim 13, wherein the background motion vectors are determined based on a depth map for the first image.

19. The method of claim 13, wherein the scaling factor is further based on an average of the magnitude of the motion vectors of the plurality of motion vectors within the portion of the foreground of the scene of the first image.

20. The method of claim 13, further comprising:
determining the foreground of a scene of the first image is greater than a threshold area; and
generating, based on determining the foreground of the scene of the first image is greater than the threshold area, a global transformation matrix based on motion vectors of the plurality of motion vectors within the foreground of the scene of the first image.
